(19) United States
(12) Patent Application Publication
(10) Pub. No.: US 2021/0093902 A1
(43) Pub. Date: Apr. 1, 2021

(54) AIR POLLUTION MASK FOR CANINES OR THE LIKE

(71) Applicant: Good Air Team, LLC, Austin, TX (US)

(72) Inventors: Kirby Barton Holmes, Austin, TX (US); Evan Wescott Daugherty, Austin, TX (US)

(73) Assignee: Good Air Team, LLC, Austin, TX (US)

(21) Appl. No.: 16/858,932

(22) Filed: Apr. 27, 2020

Related U.S. Application Data
(60) Provisional application No. 62/908,788, filed on Oct. 1, 2019.

(51) Int. Cl. A62B 18/06; A62B 23/02; A62B 18/08; A62B 18/10

(52) U.S. Cl. CPC A62B 18/06; A62B 18/10; A62B 18/084; A62B 23/025

(57) ABSTRACT

A canine mask is provided for filtering air pollution from inhaled air. A main body of the mask may comprise flexible/semi-flexible material that is formed in a generally hollow cylindrical-, hollow frustrum-, or hollow frustoconical-shape. The proximal end of the main body may comprise strap(s) providing a securing mechanism, and the distal end may provide a panting valve. An adjustment mechanism may be provide near the proximal end to allow adjustment of muzzle circumference. The main body may provide a filter pocket where an air filter may be placed to filter inhaled air, whereas the panting valve allows exhaled air to exit. When properly placed and secured on a canine's snout, the mask forms a seal so that exhaled air exits the panting valve and inhaled air only enters through the air filter cleaning incoming air of pollutants.

### RELATED APPLICATIONS

This application claims the benefit of U.S. Provisional Patent Application No. 62/908,788 filed on Oct. 1, 2019, which is incorporated herein by reference.

### FIELD OF THE INVENTION

This invention relates to a mask for animals with snouts, such as canines. More particularly, to mask for filtering breathable polluted air for such animals.

### BACKGROUND OF INVENTION

Canines or dogs breathe air from the environment in which they live and move. This air can be polluted with gases (e.g. ammonia, carbon monoxide, sulfur dioxide, nitrous oxides, methane, chlorofluorocarbons, etc.), particulates, and/or biological molecules such as airborne pathogens that may impact health. In particular, polluted air with poor air quality is detrimental to the lungs of a canine, which it is not able to process toxic constituents, but rather absorbs the toxic constituents. Harmful air pollutants in the environment produced by industrial factories, vehicle emissions, smoke caused by fire, chemicals, allergens, molds, dust, ash, airborne pathogens, or the like are all health risks to canines.

Domesticated canines as relational companions, service animals, security animals, search and rescue dogs, police canines, recovery animals, or the like are all potentially at risk of air pollution related dangers, especially in high pollution environments. There is a need to protect dogs with an air purification filter system while the animal is in a polluted air environment.

### SUMMARY OF INVENTION

In one embodiment, a canine mask is provided for filtering air. The main body of the mask may comprise flexible/semi-flexible material that is formed in a generally hollow cylindrical-, hollow frustrum-, or hollow frustoconical-shape. The proximal end of the main body may comprise strap(s) providing a securing mechanism, and the distal end may provide a panting valve. An adjustment mechanism may be provide near the proximal end to allow adjustment of muzzle circumference. The main body may provide a filter pocket where an air filter may be placed to filter pollutants from inhaled air, whereas the panting valve allows exhaled air to exit.

The cylindrical-, hollow frustrum-, or hollow frustoconical-shaped portion of the main body fits on a canine's snout to form a seal, and the strap(s) may be placed behind the canine's head or neck and secured and/or adjusted with the securing mechanism. The adjustment mechanism may be adjusted to match muzzle circumference of the canine wearing the mask. In some embodiments, the main body is elastic materials to improve fitment and maintain sealing.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows a nonlimiting example of an air pollution mask for canines or the like;

FIG. 2 shows another view of an embodiment of a mask;

FIG. 3 shows a bottom view of an embodiment of a mask;

FIG. 4 shows a bottom view of an embodiment of a mask;

FIG. 5 provides a sizing chart for different breeds of canine;

FIGS. 6A-6E show yet another nonlimiting embodiment of a mask; and

FIG. 7 shows a nonlimiting example of an air filter.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise. Additionally, any ranges shall be understood to include the end values provided.

Canine generally refers to the genus of Canis, which includes dogs. While dogs do not encompass the entire genus of Canis, it shall be understood by one of ordinary skill that term dogs as utilized herein is merely utilized as a nonlimiting example for illustrative purposes. While the invention discussed herein is primarily intended for canines, it shall be understood by one of ordinary skill that the invention may be suitable for other animals, particularly animals with somewhat similar snout features or elongated snouts.

The snout, muzzle, or the like is the protruding portion of an animal's face, comprising its nose, mouth, and jaw. However, various breeds of canines exist that vary widely in size, weight, snout shape & size, and the like. As such, canine snout shape, length, circumference, and the like may vary significantly. Additionally, canine physiology differs from humans—perhaps most notably in that canines lack sweat glands. As such, canines may pant or breathe with short quick breaths to regulate body temperature. Canines are also capable of breathing in through the nose while simultaneously pushing air out or circular breathing. Additionally, there are various notable differences from humans tied to the significant differences in olfactory senses.

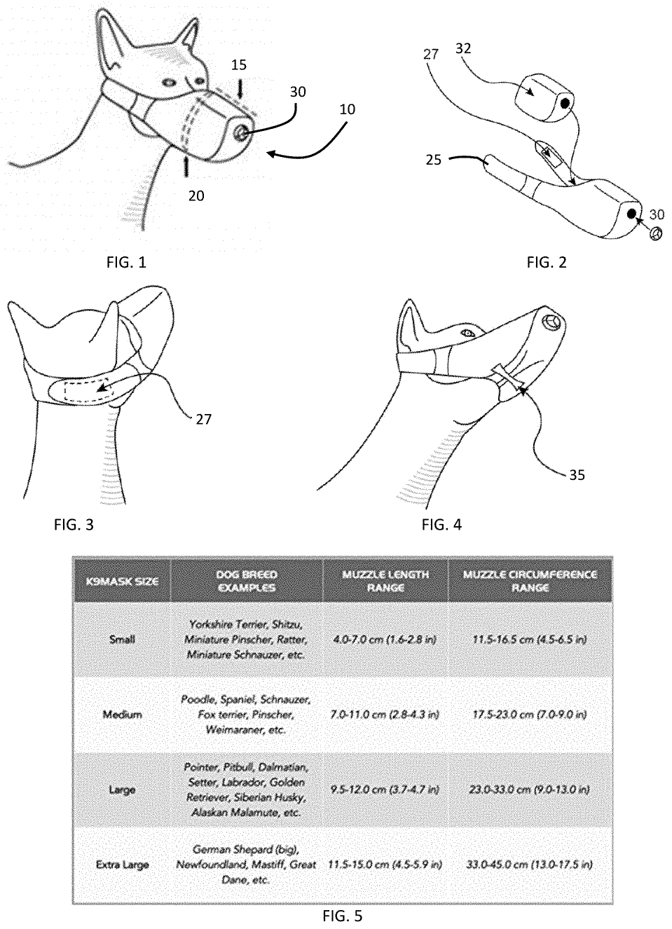

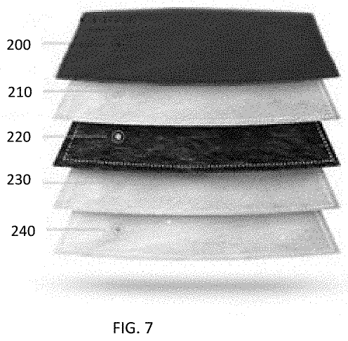

FIG. 1 shows a nonlimiting example of an air pollution mask for canines or the like. As the snout of canines is generally pointed or conical, a significant portion of the mask 10 is generally in the shape of a hollow cylinder, hollow frustum, or hollow cone with truncated tip where the proximal end fits on the snout and the distal end is near the nose. As shown, the outer surface length of the hollow cylindrical-, frustrum-, or conical-shape may be referred to herein as the muzzle length 15. The hollow cylindrical-, frustrum-, or conical-shape portion of the mask 10 may have a circular or ovular base that is open to accommodate the snout, and the circumference near the proximal end may defined a muzzle circumference 20. The distal end is covered to prevent undesirable entry of air pollution. The shape and/or size of the mask 10 is chosen to cover the entirety of the canine's mouth and nose when worn. It is important to maintain a seal at this open end of the mask so the features should allow it to be secured tightly to create and maintain the seal. This may be challenging as a canine's different breathing abilities and other differences, as well as likelihood frequent head movement present additional concerns. The mask 10 further comprises at least one strap 25 extending from the proximal end of the mask 10 that may be wrapped around behind the head of a canine and properly secure and/or adjust the mask in a desired position. Because the strap 25 is positioned to wrap around the head, it does not impair flexible movement and allows the canine to freely move around the head without impacting fitment. The strap(s) 25 may cover ends of the canine's mouth in some embodiments, but other embodiments may not require such arrangement when the mouth is already covered by the rest of the mask 10. The truncated tip of the cone may provide an exhalation or panting valve 30 near where a canine's mouth would be when worn. The panting valve 30 is a one-way valve allowing air to escape when pressure is above a certain level, but does not allow air to enter. Because of circular breathing abilities of canines, concerns differ from humans in that cross mingling of polluted air is a greater risk. FIG. 2 shows another view of an embodiment of a mask. The strap(s) 25 may provide any suitable securing mechanism 27 that allows for securing and/or adjusting the mask on the snout or around the canine's head or neck, such as but not limited to hook and look fastening tape (e.g. Velcro), buckles, snap fasteners, elastic or elastic fasteners, clips, ties, and/or buttons, to aid forming a seal about the canine's snout. Notably, the strap(s) 25 and securing mechanism 27 are positioned to avoid or minimize restriction to range of motion. As shown in FIG. 3, two straps are provided in some embodiments, and the ends of the straps may be wrapped around a canine's neck or head. In a nonlimiting embodiment, the securing mechanism 27 may secure the ends together utilizing Velcro to fit the mask as desired. Other embodiments may provide a single strap that wraps entirely around the canine's neck or head with Velcro on the end of the strap and Velcro on the proximal end of the mask that mate together. Returning to FIG. 2 and not shown in the prior views, the mask 10 may include a filter insert 32 that may be removable and/or replaceable from the mask in some embodiments. While the filter insert 32 is inserted into an opening of the proximal end of the mask in the embodiment shown, other embodiments may provide a pocket provided by the mask 10 that the filter may be inserted into. The filter insert filters pollutants that may be present in inhaled air. The panting valve 30 may also be optionally removable and/or replaceable in some embodiments, but may be permanently secured in place in other embodiments. FIG. 4 shows a bottom view where an adjustment mechanism 35 may allow adjustment of muzzle circumference to aid forming a seal about the canine's snout. In some embodiments, the adjustment mechanism 35 may be positioned near the proximal end of conical-shaped portion of the mask near the back of the jaw. The adjustment mechanism 35 may be any suitable mechanism, including the options noted above for securing mechanism 27. This positioning allows a canine to open the mouth during panting with minimal to no restriction. As a nonlimiting example shown in FIG. 7A, the adjustment mechanism may be a Velcro strap. Other embodiments may involve fastening the adjustment mechanism to securely place the mask as desired (e.g. fastening buckles snap fasteners, elastic or elastic fasteners, clips, ties, and/or buttons in position(s) that will maintain a secure fit).

Whereas human mouths, noses, and facial shapes allow for fairly common mask designs suitable for a large portion of the population, canine snouts may differ significantly depending on breed—making it very difficult to provide mask designs suitable for many breeds. Further complicating the matter, canine physiology differs from humans in that panting is necessary to regulate body temperature. As such, a mask for canines must not only address widely varying snouts of different breeds, but also allow for panting while the mask is being worn.

Referring back to FIG. 1, the design of mask 10 allows for a wide range of muzzle lengths 15 and/or circumferences 20 to accommodate various breeds of canines. The size of a mask 10 is selected to cover the entirety of a canine's mouth and nose when worn. As nonlimiting examples, the muzzle length 15 of mask 10 may range from 1.6-5.9 inches. In yet another nonlimiting example, the muzzle length 15 may be selected to provide different sizes, each accommodating numerous canine breeds, e.g. small ranging from 1.6-2.8 inches, medium ranging from 2.8-4.3 inches, large ranging from 3.7-4.7 inches, and/or extra-large ranging from 4.5-5.9 inches, where the top value indicates the muzzle length 15 of the mask 10. As nonlimiting examples, the muzzle circumference 20 of mask 10 may also vary a wide range from 4.5-17.5 inches. In yet another nonlimiting example, the muzzle circumference 20 may be selected to provide different sizes, each accommodating numerous canine breeds, e.g. small ranging from 4.5-6.5 inches, medium ranging from 7-9 inches, large ranging from 9-13 inches, and/or extra-large ranging from 13.3-17.5 inches. Further nonlimiting examples may pair the muzzle lengths 15 of the size examples with the muzzle circumferences 20 of the examples discussed above. FIG. 5 provides a nonlimiting example of sizing for different breeds of canine, where the upper value indicates the muzzle length and muzzle circumference of the mask 10. The ranges shown indicates possible range of snout lengths and circumferences the different sizes may be suitable for, as well as canine breeds that the sizes may be suitable for.

Where the mask 10 is generally the shape of a hollow cylinder, frustrum, or cone, the shape may taper from the proximal end towards distal end in some embodiments. Additionally, the hollow cone does not require a straight taper, and may be convex or concave in some embodiments. In some embodiments, the tapering may be minimal to allow the canine to pant when wearing the mask, as the canine's mouth may be partially open when panting. In other words, the shape of the mask 10 intentionally does not exactly match the dimension of a canine's snout when the mouth is closed or even the dimensions when the canine is panting. Instead, the shape and/or size of the mask 10 takes into account different sizes and/or shapes for different breed of canines, and also factors in the need for comfortably allowing the canine to pant even when the mask is worn. It shall be apparent that the mask fits over the entirety of a canine nose and mouth to form and maintain a seal. Because of the wide mouth of canines, a thick strap 25 may be preferred in some embodiments to fully cover the mouth if necessary—however, some embodiments may facilitate thinner and/or smaller straps.

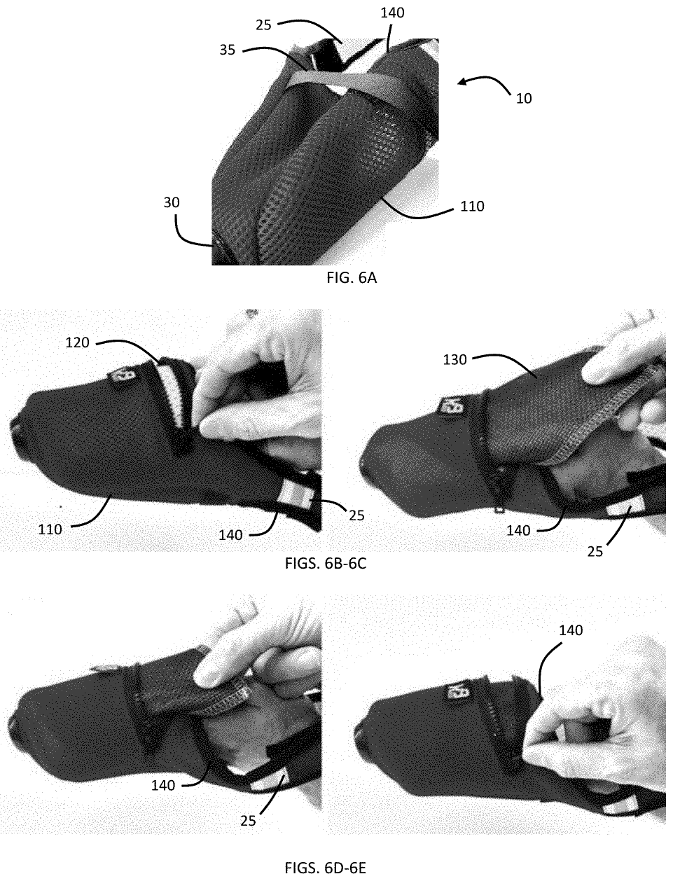

FIGS. 6A-6F show yet another nonlimiting embodiment of a mask 10. In some embodiments, main body 110 of the mask may be generally made of a flexible or semi-flexible material. In some embodiments, the main body's 110 material may be elastic or semi-elastic. At least a portion of the mask 10 is also breathable to facilitate breathing, such as a pocket 120 of the main body 110. As a nonlimiting example, the upper and/or side portion(s) of the mask may be breathable. A filter 130 is utilized to cover the breathable portions or roughly ¾ of the mask. Nonlimiting examples may include, but are not limited to, a multi-layer mesh fabric, polyester mesh, nylon, or the like. Further, in some embodiments, the remainder of the main body 110, excluding the area covered by the pocket 120, may be non-breathable to prevent unfiltered air from entering the mask. As a nonlimiting example, the bottom and tip portion(s) of the mask may be breathable. Nonlimiting examples may utilize non-breathable materials, such as non-breathable nylon material, as portions of the main body 110 separate from breathable sections or by combining non-breathable materials with the main body in sections where breathability in not desired. In some embodiments, the main body 110 of the mask, including the strap(s) 25, may be formed from one or more pieces of the semi-flexible, elastic, and/or breathable material(s) jointed together. Nonlimiting examples may include, but are not limited to, mesh materials cut in the desired shape for the flexible, breathable upper, side, and/or strap portions of main body 110. Further, a mesh and non-breathable material may be cut in the desired shape for the bottom portion of the main body 110. The bottom and upper/side portions may be sewn or joined together. In some embodiments, reflective material may be provide on the mask, such as on the straps. Further, the securing mechanism (not shown), panting valve 30, and adjustment mechanism 35 may be attached to the main body 110 in any suitable manner desired, including sewing, adhesives, friction fit, etc. Nonlimiting examples may include, but are not limited to, sewing Velcro to the strap(s) of the securing mechanism, sewing Velcro to the adjustment mechanism 35 of the main body 100, location, and/or adhesively securing the panting valve 30 to the main body. It shall be apparent that the flexible or semi-flexible main body 110 allows the mask to conform to the snout of the animal wearing the mask. Additionally, the securing mechanism and adjustment mechanism 35 may allow for additional adjustment of fit. This not only allows for adjustment for different skull diameters and snout circumferences, but also adjustment of pressure or tightness of the mask's fit on the snout. The flexibility and/or elasticity of the main body 110 allows the mask 10 various range of motion (e.g. up, down, left, right, etc.) while still maintaining a secure fit. It should also be noted that the panting valve 30 provides structural support for the tip or distal end of the mask 10 that maintains the shape, as it is more rigid than the main body 110 and avoid collapsing. During inhalation and exhalation, the pressure changes inside the mask 10 and the main body 110 may flex due to the changes in pressure. While the canine's snout aids shape retention to a degree by the position maintained in the mask with the securing mechanism and adjustment mechanism, the added shape retention provided panting valve 30 prevents collapse that could negatively impact fitment. The material selected for main body 110 and air filter 130 add some degree of structure for the mask 10, but no single component acts as a key structural element and the combination of components provides the desired shape retention. While the embodiment shown similar materials being utilized for the main body 110 an straps 25, other embodiments may utilized different materials if desired. In some embodiments, a proximal end of the mask 10 may further provide flexible material 140 along the edges or along the bottom edges of the cylindrically-, frustrum-, or cone-shaped mask 10 and/or the strap(s) 25 to improve fitment and/or sealing, as well as to prevent fraying of the materials of the main body 110 if needed. Flexible material 140 may be desirable along these bottom edges and/or strap(s) 25 to improve maintenance of a seal on the snout, thereby allowing these portions to flex, stretch, and/or contract when necessary to maintain a seal. On the cylindrical snout shaped cone part of the mask covering the nose and mouth there is an expanding and contracting feature to provide a form fitting seal to the dog's snout to keep polluted air from entering the mask before being breathed into the animal. This form fitting mask feature allows only air passing through the air filter layers to be inhaled by the dog.

As shown in FIGS. 6A-6F, some embodiments of the mask may provide a filter pocket 120 formed by main body 110 that is breathable to allow inhaled air to be filtered of pollutants. As a nonlimiting example, the multi-layer material of the main body 110 provides a pocket 120 accessible by a zipper or any other mechanism. The pocket 120 allows a filter 130 to be inserted, removed, and/or replaced when desired. Filter 130 conforms or matches the shape of the pocket 120 to fully fill the pocket and filter air pollutants from inhaled air. FIG. 7 shows a nonlimiting example of an air filter that filters air pollution. Nonlimiting examples of an air filter 130 may include a multi-layer filter, such as one comprising a form fit layer 200, large particle filter layer 210, activated carbon layer 220, particulate filtering layer 230 (e.g. NIOSH air filtration rating N95, PM 2.5), and/or inner protective layer 240. The form fit layer 200 is somewhat more rigid (though still flexible) than the other materials utilized in the filter and aids fitment of the filter in the mask to fully fill and cover breathable areas of the mask. As a nonlimiting example, the form fit layer 200 may be a polypropylene mesh. The large particle filter layer 210 aids filtering of dust and/or large particles, and may also protect other layers (e.g. activated carbon layer 220) from degradation, such as from user handling or the like. As a nonlimiting example, the large particle filter layer 210 may be polypropylene spunbound nonwoven material. The activated carbon layer 220 may aid purification by being readily reactive with oil vapors, other hydrocarbons, ozone, and the like, and may also aid odor removal. Particulate filtering layer 230 filters particulates from air, and any suitable known materials(s) with a suitable NIOSH air filtration ratings. As nonlimiting examples, the particular filtering layer 230 may be materials with a NIOSH rating of N95 or better, N99 or better, P99 or better, or the like. The inner protective layer 240 is soft, flexible layer that filters dust and/or large particles, and may also protect other layers (e.g. filter layer 230) from degradation, such as from user handling, friction, or the like. As a nonlimiting example, the inner protective layer 240 may be polypropylene spunbound nonwoven material.

FIGS. 6A-6E and 7 represent a prototype of a nonlimiting embodiment of the mask and filter. While these prototypes are discussed in detail above, the exemplary prototypes discussed herein are included to demonstrate particular aspects of the present disclosure. It should be appreciated by those of ordinary skill in the art that the methods described in the examples that follow merely represent illustrative embodiments of the disclosure. Those of ordinary skill in the art should, in light of the present disclosure, will appreciate that many changes can be made in the specific embodiments described and still obtain a like or similar result without departing from the spirit and scope of the present disclosure.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described, including various combinations of the different elements, components, steps, features, or the like of the embodiments described, and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A mask for filtering air for a canine or other animals, the mask comprising:
a main body formed in a hollow cylindrical-, hollow frustrum-, or hollow truncated cone-shape, wherein the main body is formed from a flexible material, and a pocket is provided by the main body;
at least one strap extending from a proximal end of the main body that is capable of being wrapped around a canine's or other animal's head or neck;
a securing mechanism provided by the at least one strap, wherein the securing mechanism secures the at least one strap around the canine's or other animal's head or neck to aid forming a seal about the canine's or other animal's snout;
an adjustment mechanism provided near the proximal end of the main body, wherein the adjustment mechanism allows a muzzle circumference to be adjusted to aid forming the seal about the canine's or other animal's snout;
a panting valve provided at a distal end of the main body, wherein the panting valve allows air to exit the mask during exhalation and does not allow air to enter during inhalation; and
an air filter that is shape to conform to the pocket, wherein the air filter removes pollutants from inhaled air.

2. The mask of claim 1, wherein at least a portion of the main body comprising the pocket is formed of a breathable material.

3. The mask of claim 2, wherein a remainder of the main body, excluding the pocket, utilizes non-breathable material or combines the non-breathable material with the main body.

4. The mask of claim 1, wherein the main body is sized to cover the entirety of a mouth and nose of the canine or other animal when worn.

5. The mask of claim 1, wherein the main body is sized to allow a mouth of the canine to open during panting.

6. The mask of claim 2, wherein the main body is elastic to aid fitment and maintaining a seal.

7. The mask of claim 1, wherein the panting valve maintains a shape of the distal end of the main body.

8. The mask of claim 1, wherein the panting valve is positioned close to the mouth of the canine when worn.

9. The mask of claim 1, wherein the at least one strap and the securing mechanism allow for flexible movement when secured.

10. The mask of claim 1, wherein the adjustment mechanism is positioned near a rear jaw of the canine when worn to minimize impact on panting.

11. The mask of claim 1, wherein a muzzle length and the muzzle circumference of the mask is selected to accommodate various breeds of canines.

12. The mask of claim 11, wherein the muzzle length of the mask is between 1.6-5.9 inches and the muzzle circumference of the mask is between 4.5-17.5 inches.

13. The mask of claim 12, wherein the muzzle length of the mask is between 1.6-5.9 inches.

14. The mask of claim 12, wherein the muzzle circumference of the mask is between 4.5-17.5 inches.

15. The mask of claim 1, wherein the air filter comprises a form fit layer, large particle filter layer, activated carbon layer, particulate filtering layer, and/or inner protective layer to filter dust, particulates, and/or other air pollutants.

16. The mask of claim 1, wherein a portion of the main body is formed from a mesh material.

17. The mask of claim 1, wherein the panting valve is removable and/or replaceable.

18. The mask of claim 1, wherein the air filter is removable and/or replaceable.

19. The mask of claim 1, wherein the securing mechanism is selected from hook and loop fastening tape, buckles, snap fasteners, elastic or elastic fasteners, clips, ties, and/or buttons.

20. The mask of claim 1, wherein the adjustment mechanism is selected from hook and look fastening tape, buckles, snap fasteners, elastic or elastic fasteners, clips, ties, and/or buttons.
